(19) United States
(12) Patent Application Publication
(10) Pub. No.: US 2003/0010627 A1
(43) Pub. Date: Jan. 16, 2003

(54) Metal surface-treating method

(76) Inventors: Hiroshi Chihara, Kawasaki-shi (JP); Kenji Tsuge, Yokohama-shi (JP); Yutaka Kinose, Tokyo (JP); Toru Hata, Ichikawa-shi (JP); Eriko Okuno, Ichikawa-shi (JP)

Correspondence Address: JORDAN AND HAMBURG LLP, 122 EAST 42ND STREET, SUITE 4000, NEW YORK, NY, 10168, US

(21) Appl. No.: 10/052,606

(22) Filed: Jan. 17, 2002

(30) Foreign Application Priority Data
Jan. 17, 2001 (JP) 2001-008717

(51) Int. Cl. C25B 15/00; C25B 9/00; C25B 9/04; C25C 3/16; C25C 3/20; C25D 17/00; C25D 21/12; B23H 3/02; B23H 7/04; B23H 7/14; C25F 7/00

(52) U.S. Cl. 204/232; 204/237; 204/228.6

(57) ABSTRACT

The present invention is to provide a metal surface-treating method which is capable of forming a zinc phosphate coat suitable for the cationic electrodeposition coating of a metallic shaped product, particularly a metallic shaped product having both an iron type metallic surface and a zinc type metallic surface and is suited to a closed system.

A metal surface-treating method which comprises a chemical conversion step of dipping a substrate in an acidic aqueous zinc phosphate solution, and using an aqueous zinc nitrite solution as an accelerator, said aqueous zinc nitrite solution being substantially free of calcium ion and containing 0 to 6500 ppm of sodium ion and 0 to 20 ppm of sulfate ion in case of assuming the concentration of zinc nitrite [Zn(NO₂)₂] to be 10 weight % as NO₂.

### FIELD OF THE INVENTION

The present invention relates to a method for zinc phosphate chemical conversion treatment of metallic shaped products, such as automotive bodies, household electrical appliances, steel furniture and so forth.

### BACKGROUND OF THE INVENTION

Metallic shaped products, such as automotive bodies, household electrical appliances, and steel furniture are generally subjected to zinc phosphate chemical conversion treatment prior to coating. This treatment process is generally carried out by a spray technique or a dip technique but in cases where, as it is true of an automotive body, the substrate has an intricate multiple-pocket structure and the corrosion resistance after coating is an important quality parameter, it is common practice to serially apply dip chemical conversion and coating with cationic electrodeposition coating. Moreover, regarding the substrate as such, one having both an iron type surface and a zinc type surface is usually applied thereto.

The conventional zinc phosphating of metals is generally carried out in a sequence of degreasing-aqueous washing-aqueous washing-chemical conversion-aqueous washing-aqueous washing. In the chemical conversion stage, the reagents are replenished to make up for the consumption of chemical conversion bath components due to the chemical conversion film formation and the carry-over in order that the concentrations of zinc and other metal ions, total acidity, acid ratio, and other parameters in the treating bath may be controlled at constant values. Moreover, generally the concentration of NO₂ in the treating bath is controlled so as to be constant by supplying an aqueous solution of sodium nitrite as a chemical conversion accelerator. However, the above control technology is tantamount to adding a sodium ion which is unnecessary for chemical conversion and, as such, is uneconomical and, in addition, as the sodium ion concentration is increased, the pH of the treating bath is elevated so that the conversion reagent components are precipitated in the treating bath. Moreover, NO₂ in the treating bath is oxidized to nitrate ion so that the nitrate ion concentration of the treating bath is increased.

Meanwhile, in the phosphating line in common use today, the treating bath is partially carried over to the aqueous washing step as mentioned above but if supplementations are made to make up for the losses due to such carry-overs, it will not happen that the sodium and nitrate ions accumulate in the treating bath, thus allowing the balance of ion concentrations in the treating bath to be successfully maintained. However, in cases where the quantity of the above treating bath which is carried over to the downstream aqueous washing step is small and the composition of the reagent replenished is not compatible with the parameter settings of the chemical conversion treatment line and hence, leads to the buildup of some of the components, the balance of consumption and supply of ions of the treating bath composition is disturbed. For example, the sodium ion and nitrate ion accumulate abnormally, with the result that chemical conversion defects such as yellow rust and thin spots may develop. Therefore, if nitric acid instead of sodium nitrite can be used as a chemical conversion accelerator, the accumulation of sodium ion may be avoided. However, nitric acid is so unstable that it does not exist under normal conditions and, hence, cannot be utilized.

Furthermore, in the above chemical conversion line, the carry-overs of the treating bath are washed off with a large quantity of water and discharged from the equipment but this poses a problem from the standpoint of protection of water quality and environment. Therefore, for resolving the above problem, there has been utilized the method which comprises constituting the aqueous washing step as a multi-stage system and recycling the overflowing washing water from a downstream stage to an upstream stage for use as washing water to thereby cut down on the supply of fresh washing water or the method which comprises treating the washing water from the chemical conversion line by reverse osmosis membrane treatment or evaporation in a closed system to recover the washing water and reuse it as a supplement to the chemical conversion treating bath or as washing water. However, even in these methods, too, adding an aqueous solution of sodium nitrite as an accelerator to said zinc phosphate chemical conversion treating bath results in a tendency toward accumulation of sodium ion in the treating bath, thus posing a major problem in the implementation of a closed system.

The inventors of the present invention proposed in JP Application 2000-141893 an aqueous zinc nitrite solution which is obtainable by reacting zinc nitrate with calcium nitrite followed by purification and is of use as a substantially sodium ion- and sulfate ion-free chemical conversion accelerator for metal surface treatment.

### SUMMARY OF THE INVENTION

The object of the present invention is to provide a metal surface-treating method which is capable of forming a zinc phosphate coat suitable for the cationic electrodeposition coating of a metallic shaped product, particularly a metallic shaped product having both an iron type metallic surface and a zinc type metallic surface and is suited to a closed system.

The present invention is directed to a metal surface-treating method

which comprises a chemical conversion step of dipping a substrate in an acidic aqueous zinc phosphate solution,

and using an aqueous zinc nitrite solution as an accelerator,

said aqueous zinc nitrite solution being substantially free of calcium ion and containing 0 to 6500 ppm of sodium ion and 0 to 20 ppm of sulfate ion in case of assuming the concentration of zinc nitrite [Zn(NO₂)₂] therein to be 10 weight % as NO₂.

The acidic aqueous zinc phosphate solution mentioned above may contain 0.5 to 2 g/L of zinc ion, 5 to 30 g/L of phosphate ion, 0.2 to 2 g/L of manganese ion, and 0.05 to 0.3 g/L as NO₂ of zinc nitrite.

Further, the acidic aqueous zinc phosphate solution mentioned above may contain 0.3 to 2 g/L of nickel ion.

Firthermore, the acidic aqueous zinc phosphate solution mentioned above may contain 3 to 30 g/L of nitrate ion.

The substrate mentioned above is preferably a metal product having an iron type surface and a zinc type surface or one having an iron type surface, a zinc type surface and an aluminum type surface.

### BRIEF DESCRIPTION OF THE DRAWING

FIG. 1 is a schematic diagram showing the electrodialyzer used in Preparation Example 1.

### DETAILED DESCRIPTION OF THE INVENTION

The metal surface-treating method according to the present invention employs an aqueous zinc nitrite [Zn(NO₂)₂] solution. In the metal surface-treating method according to the invention, said aqueous zinc nitrite solution is used as an accelerator to be added to an acidic aqueous zinc phosphate solution and replenished as needed. In the metal surface treatment, an accelerator is generally added to a chemical conversion treating bath for promoting the chemical conversion reaction forming a chemical conversion coat on a metal surface, with the effect of enabling a chemical conversion treatment even at low temperature and reducing the conversion treatment time.

The above aqueous zinc nitrite solution contains 5 to 40 weight % of NO₂ based on its weight. If the NO₂ content is less than 5 weight %, the quantity of the accelerator solution to be replenished during a chemical conversion treatment is undesirably increased. If the content exceeds 40 weight %, the levels of sodium ion and sulfate ion as impurities are increased during the production of said aqueous zinc nitrite solution, with the result that the chemical conversion coat is adversely affected. The preferred range is 9 to 20 weight %.

When the concentration of NO₂ in said aqueous zinc nitrite solution is 5 to 40 weight %, preferably 9 to 20 weight %, the zinc ion concentration is 4 to 28 weight %, preferably 6 to 14 weight %, and the zinc nitrite concentration is 9 to 68 weight %, preferably 15 to 34 weight %.

The above aqueous zinc nitrite solution is substantially free of calcium ions. If a calcium ion is present during acceleration of the chemical conversion, blending the accelerator with a zinc phosphating bath results in the formation of calcium phosphate sludges in the surface-treating bath and although these sludges are usually recovered periodically to prevent accumulation in the treating bath, the recovery of sludges is a troublesome procedure and not commercially recommendable. The term “substantially free of calcium ion” is used in this specification to mean that the concentration of calcium ion in said aqueous zinc nitrite solution as measured by ICP emission spectrometry is not more than 100 ppm, preferably not more than 10 ppm.

The above aqueous zinc nitrite solution contains sodium ion and/or sulfate ion as impurity in some cases. The permissible range for sodium ion and sulfate ion in said aqueous zinc nitrite solution is 0 to 6500 ppm, preferably 0 to 4000 ppm, usually 500 to 2000 ppm for sodium ion and 0 to 20 ppm, preferably 0 to 15 ppm for sulfate ion in case assuming the concentration of zinc nitrite in said aqueous zinc nitrite solution to be 10 weight % as NO₂.

Exceeding each of the above upper limit concentration of sodium ion or sulfate ion results in accumulation of sodium ion or sulfate ion in the zinc phosphating bath by replenishment of the accelerator and, hence, adverse effects on chemical conversion. Particularly in cases where the chemical conversion treatment is carried out in a closed system involving multi-stage aqueous washing or reverse osmosis membrane treatment or evaporation for the reduced consumption of washing water or the reuse thereof, the above adverse effects are quite pronounced and this is undesirable.

The sodium ion concentration referred to above is determined by atomic absorption spectrometry. To determine the above-mentioned sulfate ion concentration, sulfur (S) is measured by ICP emission spectrometry and the result is converted to sulfate ion concentration.

The method of producing said aqueous zinc nitrite solution comprises a first step in which a soluble zinc compound and a soluble alkali nitrite compound are subjected, as starting materials, to double decomposition using ion exchange membranes as diaphragms to electrolytically synthesize an aqueous zinc nitrite solution, and a second step in which the aqueous zinc nitrite solution thus obtained is purified.

The above first step is carried out preferably as follows. Thus, an electrodialyzer equipped with unit cells each having one concentrating chamber and two desalting chambers flanking said concentrating chamber as constructed by disposing cation exchange and anion exchange membranes between the cathode and anode in an alternating manner is employed. With each desalting chamber being constructed by an anion exchange membrane on the anode side and a cation exchange membrane on the cathode side, the aqueous zinc compound solution is fed to the desalting chamber on the anode side while an aqueous alkali nitrite solution is fed to the desalting chamber on the cathode side and an electric current is supplied to the device. In this arrangement, the zinc ion is caused to diffuse into the concentration chamber, flanked by desalting chambers, through a cation exchange membrane while NO₂ is caused to diffuse into the concentrating chamber through an anion exchange membrane to give the objective aqueous zinc nitrite solution. For use in the above first step, the reaction temperature is 10 to 50° C., the current density is 1.0 A/dm³ to limiting current density, and the current time is about 10 to 50 hours, although it is not particularly restricted.

The above aqueous zinc compound solution is an aqueous solution prepared by dissolving a soluble zinc compound in water. The zinc compound mentioned above is not particularly restricted but includes, for example, zinc sulfate, zinc nitrate, zinc chloride and zinc acetate. These may be used each independently or two or more of them may be used in combination. From commercial availability points of view, zinc sulfate among them is preferred.

The concentration of said aqueous zinc compound solution is not particularly restricted but is preferably not more than the saturation concentration at room temperature, more preferably 0.5 to 2.0 mol/L, still more preferably 0.9 to 1.3 mol/L.

The aqueous alkali nitrite solution, the counterpart starting material, is an aqueous solution prepared by dissolving an alkali nitrite in water. The above alkali nitrite is not particularly restricted but includes, for example, sodium nitrite, potassium nitrite and lithium nitrite, and these may be used each independently or two or more of them may be used in combination. From commercial availability points of view, sodium nitrite among them is preferred.

The concentration of said aqueous soluble alkali nitrite solution is not particularly restricted but is preferably not more than the saturation concentration at room temperature, more preferably 1.5 to 6.0 mol/L, still more preferably 3.0 to 4.5 mol/L.

The cation exchange membrane mentioned above is not particularly restricted but those cation exchange membranes which are generally used in electrolytic synthesis, for instance, can be employed. For example, Selemion CMV (product of Asahi Glass Co.), Neocepta CM-1 (product of Tokuyama Soda Co.), and Nafion 324 (product of DuPont) may be mentioned.

The anion exchange membrane mentioned above is not particularly restricted but those anion exchange membranes which are generally used in electrolytic synthesis, for instance, can be employed. For example, Selemion AMV (product of Asahi Glass Co.) and Neosepta AM-1 (product of Tokuyama Soda Co.) may be mentioned.

Regarding the anode and cathode for use in the above electrodialyzer, their material and configuration are properly selected according to starting materials and the configuration of the electrodialyzer to be employed. Thus, metallic materials such as platinum, iron, copper, lead, etc. and carbonaceous materials can be mentioned as examples.

In the above electrodialyzer, the anode chamber containing said anode as defined by the above electrodialyzer and an anion exchange membrane and the cathode chamber containing said cathode as defined by said electrodialyzer housing and a cation exchange membrane are supplied with an electrolyte such as Na₂SO₄, NaCl, or NH₄Br.

The concentration of the aqueous zinc nitrite solution obtained in said concentrating chamber is higher with an increasing current time but since the sodium ion concentration and sulfate ion concentration in the aqueous zinc nitrite solution, in case of assuming the concentration of zinc nitrite therein to be 10 weight % as NO₂, tend to become higher, the current time is preferably controlled so that the sodium ion concentration will be 0 to 6500 pm and the sulfate ion concentration will be 0 to 20 ppm.

Referring to the method of producing said aqueous zinc nitrite solution, the above second step may be carried out by the routine purification method. The function of this second step in terms of purification includes the removal of excess ions so as to bring the various ions mentioned above in said aqueous nitrite solution into permissible ranges, for example the removal of excess sulfate ion in the event that, in case of assuming the concentration of the aqueous zinc nitrite solution obtained in the above-mentioned first step to be 10 weight % as NO₂, the concentration of sulfate ion in said aqueous zinc nitrite solution exceeds 20 ppm, so as to bring the residual sulfate ion concentration into the range of 0 to 20 ppm.

The purification technology for said removal of excess ions includes, for example, taking the purification for the removal of sulfate ion as an example, (1) the method which comprises adding a barium ion so as to precipitate barium sulfate, (2) the method which comprises passing the solution through a cation exchange resin or an anion exchange resin, and (3) the solvent extraction method, although the above method (1) is preferred.

In the above method (1), a barium ion need be added only in slight stoichiometric excess over the residual sulfate ion; thus, the level of addition may for example be 1.05 to 1.5 equivalents, preferably 1.05 to 1.2 equivalents, relative to the residual sulfate ion.

The above aqueous zinc nitrite solution obtained by the above method is added, as a chemical conversion accelerator, to an acidic aqueous zinc phosphate solution which is a chemical conversion treating bath for the formation of a zinc phosphate coat on the metal surface.

When the above aqueous zinc nitrite solution is used for the zinc phosphating, NO₂ from zinc nitrite in the zinc phosphating bath produces an accelerating effect as does NO₂ from sodium nitrite, and since the zinc ion is a dominant component of the zinc phosphate coat, both the anion and cation of zinc nitrite can express their respective effects as surface treating agents.

The acidic aqueous zinc phosphate solution mentioned above is not particularly restricted but may for example be the conventional acidic zinc phosphating bath. The preferred bath contains 0.5 to 2 g/L, preferably 0.7 to 1.2 g/L, of zinc ion, 5 to 30 g/L, preferably 10 to 20 g/L, of phosphate ion, and 0.2 to 2 g/L, preferably 0.3 to 1.2 g/L of manganese ion.

If the zinc ion level is less than 0.5 g/L, the phosphate coat may develop thin spots and yellow rust so that the corrosion resistance after coating tends to be sacrificed. If the level of 2 g/L is exceeded, the coating adhesion tends to be decreased when the substrate is a shaped product having a zinc type metallic surface.

If the phosphate ion level is less than 5 g/L, the variation in bath composition will be increased to prevent stable formation of a satisfactory coat. If the level of 30 g/L is exceeded, an improved effect commensurate with the content may not be expected but rather the increased consumption of the reagent will lead to an economic disadvantage.

If the manganese ion level is less than 0.2 g/L, the coating adhesion and corrosion resistance after coating may possibly be decreased when a zinc type metallic surface is involved. If the level of 2 g/L is exceeded, no extraordinary effect commensurate with the content will be obtained, leading to an economic disadvantage.

An enhanced corrosion resistance can be insured by further supplementing said acidic aqueous zinc phosphate solution with 0.3 to 2 g/L, preferably 0.5 to 1.5 g/L, of nickel ion and/or 0.05 to 3 g/L, preferably 0.3 to 1.5 g/L, on an HF basis, of a fluorine compound.

The combined use of nickel ion with manganese ion will result in a further improvement in the performance of the chemical conversion coat, with greater enhancement of coating adhesion and corrosion resistance in comparison with the use of manganese ion alone.

If the fluorine compound content (on an HF basis) is less than 0.05 g/L, the variation in bath composition may possibly be increased to interfere with the stable formation of a satisfactory coat. On the other hand, if the level exceeds 3 g/L, no extraordinary effect commensurate with the content will be obtained and, rather, an economic disadvantage will result.

The above acidic zinc phosphate bath may contain 3 to 30 g/L, preferably 3 to 15 g/L, of nitrate ion. If the level of 30 g/L is exceeded, the phosphate coat may develop thin spots and yellow rust in some cases.

The ion concentrations in said acidic zinc phosphate bath are measured with Ion Chromatograph Series 4000 (manufactured by Dionex) or Atomic Absorption Spectometer 3300 (manufactured by Perkin Elmer).

In the metal surface-treating method according to the present invention, the free acidity of the treating bath is preferably 0.5 to 2.0 points. The free acidity of the treating bath can be determined by sampling 10 mL of the treating bath and titrating it with 0.1 N-sodium hydroxide using bromophenol blue as the indicator. If the acidity is less than 0.5 point, the stability of the treating bath tends to be decreased. If the acidity exceeds 2.0 points, the corrosion resistance according to the salt spray test tends to be decreased.

The aqueous zinc nitrite solution as said accelerator is preferably formulated so that it will be occurring at a level of 0.05 to 0.3 g/L as NO₂ in said acidic aqueous zinc phosphate solution. If the level is below 0.05 g/L, the chemical conversion becomes insufficient in some cases. If the level of 0.3 g/L is exceeded, the contents of sodium ion and sulfate ion as impurities in the treating bath becomes so high that the chemical conversion coat may be adversely affected in some cases.

Referring to the concentration management of NO₂ in the treating bath in the metal surface-treating method according to the present invention, it is necessary to maintain NO₂ in a definite concentration range suited to the particular treating line using said aqueous zinc nitrite solution and this is accomplished by adding said aqueous zinc nitrite solution for supplementation either continuously or periodically. The proportion of said zinc nitrite for supplementation to be added is usually determined by measuring the NO₂ concentration of the acidic zinc phosphate treating bath.

Regarding the method of measuring the NO₂ concentration in said acidic aqueous zinc phosphate solution, NO₂ can be generally quantitated using an Einhorn's tube, a device in use in fermentation industry, or a structural equivalent thereof in accordance with the protocol which is used as a practical technique in the field of phosphating industry based on the principle that nitrogen can be easily and quantitatively released from zinc nitrite and captured by using solid sulfamic acid and the concentration of NO₂ in the above treating bath can be calculated from the captured amount of nitrogen (Japanese Kokai Publication Sho-51-88442). The toner value found by the above method is such that a toner value of 1 point corresponds to a NO₂ concentration of about 44 mg/L.

Since, in the present invention, a satisfactory chemical conversion coat can be obtained when the sodium ion concentration in the chemical conversion tank is 7500 ppm on a weight basis, an aqueous sodium nitrite solution, which is inexpensive, can be added in admixture with said aqueous zinc nitrite solution provided that the sodium ion concentration in the chemical conversion tank is within the above range. In this case, too, it is necessary that the accelerator to be added is substantially free of calcium ion and contains 0 to 20 ppm of sulfate ion in case of assuming the concentration of the aqueous accelerator solution to be 10 weight % as NO₂.

The metal surface-treating method according to the invention can be applied to metal panels and shaped products thereof and is particularly suitable for the metal surface treatment of shaped products having heterogeneous metal surfaces, such as a zinc type metallic surface and an iron type metallic surface or an iron type surface, a zinc type surface and an aluminum type surface, or having a intricate multiple-pocket structure, such as automotive bodies. In the treatment of such metal surfaces, the use of said aqueous zinc nitrite solution as an accelerator helps to eliminate accumulation of sodium ion and stabilize the chemical conversion reaction, thus precluding the deterioration of corrosion resistance due to the difference in the receptivity to the treatment between different metals and the poor reactivity of the recessed parts of the substrate.

In accordance with the metal surface-treating method according to the invention, said chemical conversion bath and, as an accelerator, said aqueous zinc nitrite solution are used to treat metal surfaces by the dip technique for chemical conversion. The temperature at which the above metal surface treatment is carried out may be an ordinary treating temperature which can appropriately be selected within the range of, for example, 20 to 70° C. The time necessary for said metal surface treatment may usually be not less than 10 seconds, preferably not less than 30 seconds, more preferably 1 to 3 minutes.

In the treatment of a shaped product having an intricate multiple-pocket structure, such as an automotive body, the above dip treatment is preferably followed by a spray treatment lasting not less than 2 seconds, preferably 5 to 45 seconds. This spray treatment is preferably conducted for a sufficiently long time to wash off the sludges deposited during the above dip treatment. The present invention encompasses not only the above dip treatment but also the above spray treatment performed thereafter.

As the equipment for the pretreatment which is to be carried out prior to application of the treating method of the invention, any of the pretreating equipment heretofore available can be employed but a pretreating equipment implementing a closed system involving reverse osmosis membrane treatment or evaporation or a pretreating equipment designed to cut down on the consumption of washing water is particularly suitable. With these equipment, the accumulation of unnecessary sodium ions which has been a major problem can be drastically decreased so that the steady treating capacity can be maintained for a long time as compared with the conventional metal surface-treating methods, thus drastically reducing the frequency of renewal of the treating bath or even making it virtually unnecessary to carry out the renewal.

The above aqueous zinc nitrite solution is such that, in a case of assuming the concentration of aqueous zinc nitrite solution to be 10 weight % as NO₂, its sodium ion and sulfate ion concentrations have been reduced to not more than 6500 ppm and not more than 20 ppm, respectively, and, moreover, is substantially free of calcium ion, and in accordance with the metal surface-treating method according to the present invention which comprises the use of the above aqueous zinc nitrite solution as an accelerator, the sludge formation is decreased and a very efficient metal surface treatment can be carried out even in cases where a closed system is adopted for metal surface treatment. Thus, this method is particularly suitable for the metal surface treatment of shaped products having a zinc type metallic surface and an iron type metallic surface or an iron type surface, a zinc type surface, and an aluminum type surface or shaped products having an intricate multiple-pocket structure, such as automotive bodies.

The metal surface-treating method according to the present invention is not only capable of providing satisfactory zinc phosphate coats but also can be applied with advantage to a closed system. The zinc phosphate coat obtainable by the metal surface-treating method according to the invention is suitable for the cationic electrodeposition coating of metallic shaped products, particularly metallic shaped products having an iron type metallic surface and a zinc type metallic surface or metallic shaped products having an iron type surface, a zinc type surface and an aluminum type surface.

### EXAMPLES

The following examples illustrate the present invention in further detail without defining the scope of the invention. It should be understood that all parts and percents are by weight.

### Preparation Example 1

### Preparation of an Aqueous Zinc Nitrite Solution

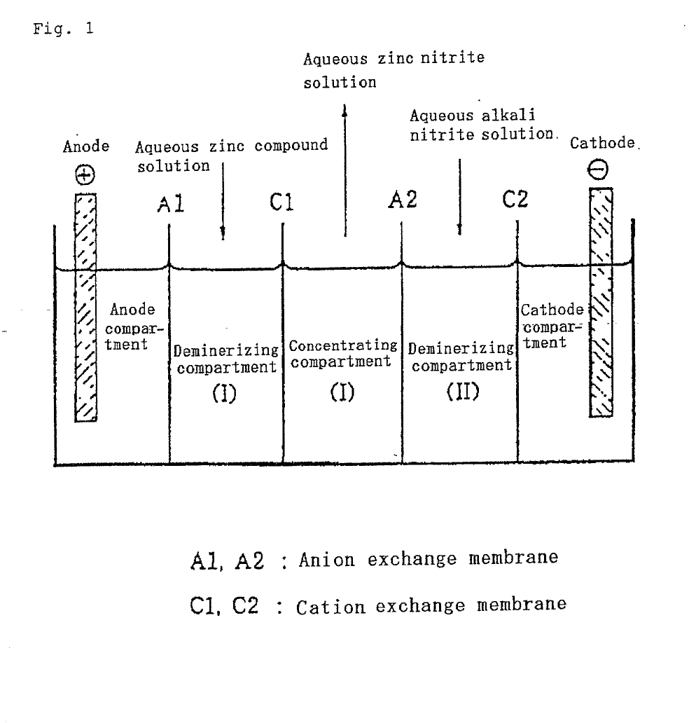

In the 5-chamber electrodialyzer using ion exchange membranes as illustrated in FIG. 1, an anion exchange membrane (product of Asahi Glass Co.; Selemion AMV) A1, a cation exchange membrane (product of Asahi Glass Co.; Selemion CMV) C1, said anion exchange membrane A2, and said cation exchange membrane C2 were serially disposed from the anode side to the cathode side to define an anode chamber, a desalting chamber (I), a concentrating chamber (I), a desalting chamber (II), and a cathode chamber, and NO₂ and Zn ions only were selectively caused to migrate through the anion exchange membrane and the cation exchange membrane, respectively, to give an aqueous zinc nitrite solution. The experiment protocol was as follows.

Thus, 575 g of zinc sulfate heptahydrate was dissolved in ion-exchange water to prepare an aqueous solution of 15% ZnSO₄ concentration and the desalting chamber (I) was supplied with the solution. On the other hand, 600 g of sodium nitrite was dissolved in ion-exchange water to prepare an aqueous solution of 30% NaNO₂ concentration and the desalting chamber (II) was supplied with the solution.

The concentrating chamber (I) was supplied with a 1.7% aqueous zinc nitrite solution. The anode chamber and cathode chamber were supplied with a 3% aqueous Na₂SO₄ solution. As the anion exchange membrane and cation exchange membrane, those having an effective membrane area of about 120 cm² each were used. While the solution in each chamber was circulated with a pump so as to maintain the concentration of the solution in each chamber uniform, a voltage of 5V was applied to each ion exchange membrane to carry out a double decomposition reaction by ion exchange membrane for 40 hours to give an aqueous zinc nitrite solution sample. In thus-obtained aqueous zinc nitrite [Zn(NO₂)₂] solution, the concentration of zinc nitrite was 17.7% and, in a case of assuming the concentration of this aqueous zinc nitrite solution to be 10% as NO₂, the sodium ion concentration was 1188 ppm, that of sulfate ion was 10 ppm, and that of calcium ion was not more than 1 ppm.

(Chemical Conversion Bath and Metal Surface Treatment)

To a surface treating bath of the following composition was added an aqueous NaNO₂ solution containing 27 weight % of NO₂, either alone or optionally in combination with the aqueous zinc nitrite solution obtained according to Preparation Example 1 to thereby maintain the NO₂ concentrations constant, as described in Reference Example 1, Reference Example 2, Example 2, and Example 3.

| | |
|---|---|
| Zinc ion: | 1000 ppm |
| Nickel ion: | 1000 ppm |
| Manganese ion: | 600 ppm |
| SiF₆: | 1000 ppm |
| Nitrate ion: | 6000 ppm |
| Phosphate ion: 15000 ppm | |

Using each of the baths prepared as above, a long-run treatment was carried out under the following conditions and the result was evaluated for the parameters listed hereunder.

(Treating Conditions)

Free acidity: 0.8 Point

Total acid: 20 to 22 mL

Treating temperature: 43±2° C.

Toner value: 2.5 to 3.0 Points

The free acidity of the treating bath was determined by sampling 10 mL of the treating bath and titrating the sample with 0.1 N-sodium hydroxide using bromophenol blue as an indicator.

The total acid of the treating bath was determined by sampling 10 mL of the treating bath with pipette, titrating it with 0.1 N-sodium hydroxide using phenolphthalein as an indicator, and regarding the amount (mL) of 0.1 N-sodium hydroxide required till a transition point of developing a pink color as the total acid.

(Evaluation Parameters)

1. The Na ion concentration of the bath: This parameter was determined with an atomic absorption spectrometer (Model 3300; manufactured by Perkin Elmer).

2. Appearance of the chemical conversion coat: This item was visually evaluated.

3. Weight of the chemical conversion coat: This parameter was determined with a fluorescent X-ray analyzer (System 3070 E, manufactured by Rigaku-sha).

4. Crystal size of the chemical conversion coat: This parameter was determined by SEM (x1500) (JSM-5310, manufactured by JEOL).

### Example 1

### Influence of the Sodium Ion Concentration of the Surface-Treating Bath

In the above surface-treating bath, the sodium ion concentration was varied and the results obtained with the following iron panels were evaluated.

Iron sheets (size/type): 70 mm×150 mm/SPC (cold-rolled steel sheet) and GA (galvanized steel sheet)

The results for the SPC steel sheet are shown in Table 1 and the results for the GA steel sheet are shown in Table 2.

TABLE 1
Investigation of the relation between sodium ion
concentration and chemical conversion coat (SPC steel panel)

| | | | | |
|---|---|---|---|---|
| Sodium | 3600 ppm | 5000 ppm | 7500 ppm | 10000 ppm |
| conc. | | | | |
| Appearance, | Wholesome | Wholesome | Wholesome | Poor |
| visual | | | | |
| Coat weight | 2.12 | 2.37 | 2.28 | 2.72 |
| Crystal | Uniform, | Uniform, | Uniform, | Not |
| size | good | good | good | uniform, |
| | | | | large |

TABLE 2
Investigation of the relation between sodium ion
concentration and chemical conversion coat (GA steel panel)

| | | | | |
|---|---|---|---|---|
| Sodium | 3600 ppm | 5000 ppm | 7500 ppm | 10000 ppm |
| conc. | | | | |
| Appearance, | Wholesome | Wholesome | Wholesome | Poor |
| visual | | | | |
| Coat weight | 3.82 | 3.58 | 3.57 | 4.50 |
| Crystal | Uniform, | Uniform, | Uniform, | Large |
| size | good | good | good | |

### Reference Example 1

### Determination of the Accumulated Amount of Na Ion-1 (Aqueous NaNO₂ Solution)

SPC substrates (70 mm×150 mm) were treated under the above conditions, supplementing for the components consumed for the formation of coats (phosphoric acid, zinc, etc.).

Various liquid quantities in the ordinary line

A: Chemical conversion tank capacity: 120 tons

B: The quantity of aqueous NaNO₂ solution used (NO₂ concentration 27 weight %, sodium ion concentration 13 weight %): 150 mL/body

C: The amount of zinc used per body: 60 g

D: The amount of chemical conversion bath carry-over per body: 5 L (the amount of carry-overs per substrate: 2 mL; 2500 panels treated)

The above step, as 1 turnover, was repeated 3 times (3 turnovers) to treat a total of 7500 panels. When the above chemical conversion bath carry-over was not recovered, the aqueous NaNO₂ solution showed a NO₂ ion concentration of 27 weight % and a sodium ion concentration of 13 weight % and the sodium ion concentration in the chemical conversion tank was steady at 3900 ppm. It was clear from the results of Example 1 that at sodium ion concentration of 3900 ppm, a satisfactory chemical conversion coat could be obtained.

### Reference Example 2

### Determination of the Accumulated Amount of Na Ion-2 (Aqueous NaNO₂ Solution)

A 5 L portion of the chemical conversion bath carry-over in Reference Example 1 was diluted with 45 L of industrial water with a pH value of 6.8 and an electrical conductivity of 234 μS/cm for use as an overflow washing water model. This dilution was adjusted to pH 3 with phosphoric acid and subjected to reverse osmosis membrane treatment using Membrane Master RUW-5A (manufactured by Nitto Denko) equipped with the commercial LF10 membrane module as a reverse osmosis system at a treating temperature of 25 to 30° C., a pressure of 1.0 to 1.1 MPa, a concentrate circulation flow rate of 6.2 to 6.3 L/min, and an effluent flow rate of 0.3 to 0.6 L/min to give 5 L of concentrate and 45 L of effluent. The sodium ion recovery rate of the above concentrate was 93%.

Thereafter, the recovered concentrate was returned to the chemical conversion bath. The above process, as 1 turnover, was repeated 3 times (3 turnovers) to treat a total of 7500 panels.

When the same aqueous NaNO₂ solution as used in the above Reference Example 1 (NO₂ concentration 27 weight %, sodium ion concentration 13 weight %) was used, the concentration kept rising with progress of the operation and ultimately the sodium ion concentration reached 56000 ppm. It was clear from the results of Example 1 that no satisfactory chemical conversion coat could be obtained at this sodium ion concentration of 56000 ppm.

### Example 2

### Determination of the Accumulated Amount of Na Ion (Aqueous Zn(NO₂)₂ Solution)

When the aqueous zinc nitrite solution of Preparation Example 1 was used, the addition of 389 mL per body was necessary to equalize the NO₂ concentration to that used in Reference Example 1. This means that 28 g of zinc was added, and the zinc was consumed in the formation of a chemical conversion coat. When the reverse osmosis membrane treatment of Reference Example 2 was carried out, the accumulated amount of sodium ion was 1320 ppm.

### Example 3

### Determination of the Accumulated Amount of Na Ion (Aqueous NaNO₂ Solution and Aqueous Zn(NO₂)₂ Solution)

When the aqueous NaNO₂ solution of Reference Example 1/the aqueous zinc nitrite solution of Preparation Example 1 was used in a ratio of 8/92 in terms of NO₂, the level of addition was 12 mL/358 mL (sodium ion: 2.00 g) and, when the reverse osmosis membrane treatment of Reference Example 2 was carried out, the sodium ion concentration in the chemical conversion tank became 5700 ppm (recovery rate 93%).

It was, therefore, understood that by using the aqueous NaNO₂ solution of Reference Example 1 and the aqueous zinc nitrite solution of Preparation Example 1 in a ratio of 8/92 in terms of NO₂, the sodium ion concentration in the chemical conversion tank could be controlled within a suitable range (3600-7500 ppm).

1. A metal surface-treating method
which comprises a chemical conversion step of dipping a substrate in an acidic aqueous zinc phosphate-solution,
and using an aqueous zinc nitrite solution as an accelerator,
said aqueous zinc nitrite solution being substantially free of calcium ion and containing 0 to 6500 ppm of sodium ion and 0 to 20 ppm of sulfate ion in case of assuming the concentration of zinc nitrite [Zn(NO₂)₂] therein to be 10 weight % as NO₂.

2. The metal surface-treating method according to claim 1
wherein the acidic aqueous zinc phosphate solution contains 0.5 to 2 g/L of zinc ion, 5 to 30 g/L of phosphate ion, 0.2 to 2 g/L of manganese ion, and 0.05 to 0.3 g/L as NO₂ of zinc nitrite.

3. The metal surface-treating method according to claim 1 or 2
wherein the acidic aqueous zinc phosphate solution contains 0.3 to 2 g/L of nickel ion.

4. The metal surface-treating method according to claim 1, 2 or 3
wherein the acidic aqueous zinc phosphate solution contains 3 to 30 g/L of nitrate ion.

5. The metal surface-treating method according to claims 1, 2, 3 or 4
wherein the substrate is a shaped product having an iron type surface and a zinc type surface or one having an iron type surface, a zinc type surface and an aluminum type surface.
